(19) United States
(12) Patent Application Publication
(10) Pub. No.: US 2025/0001775 A1
(43) Pub. Date: Jan. 2, 2025

(54) PRINTING DEVICE, ROLL MEDIUM SUPPORT DEVICE, AND AUXILIARY MEMBER

(71) Applicant: SEIKO EPSON CORPORATION, Tokyo (JP)

(72) Inventors: Takanori UMEDA, SHIOJIRI-SHI (JP); Kazuhisa KATO, MATSUMOTO-SHI (JP); Takanori KAWAI, INA-SHI (JP)

(21) Appl. No.: 18/756,779

(22) Filed: Jun. 27, 2024

(30) Foreign Application Priority Data
Jun. 27, 2023 (JP) 2023-105165

(51) Int. Cl. B41J 15/04; B41J 15/02

(52) U.S. Cl. CPC B41J 15/042; B41J 15/02

(57) ABSTRACT

An auxiliary member is configured to be attachable to and detachable from a support member. An operation section performs, switching from the position adjustment state in which movement of the support member is allowed in the extending direction of the shaft member to the positioned state in which movement of the support member with respect to the shaft member in an extending direction of the shaft member is limited and, in conjunction, switching from an unlocked state in which a lock section does not contact an inner peripheral section of the roll medium to a locked state in which the lock section contacts the inner peripheral section of a roll medium. By being attached to the support member, the auxiliary member sets the support member into the positioned state even when the operation section is in the position adjustment operation position.

The present application is based on, and claims priority from JP Application Serial Number 2023-105165, filed Jun. 27, 2023, the disclosure of which is hereby incorporated by reference herein in its entirety.

### BACKGROUND

### 1. Technical Field

The present disclosure relates to a printing device, a roll medium support device, and an auxiliary member comprising a roll medium support device for supporting a roll medium in which an elongated medium is wound into a roll.

### 2. Related Art

A printing device is known (for example, JP-A-2007-8624) that includes a roll medium support device that supports a roll medium on which an elongated medium is wound into a roll. In such a printing device, a printing section performs printing on the elongated medium (for example, roll paper) fed while being unwound from the roll medium supported by a roll medium support device (for example, a paper roll reel) that supports the roll medium.

The roll medium support device includes a shaft member which is inserted into a cylindrical core material of the roll medium and a pair of support members (flange sections) that are attached to the shaft member so as to sandwich the roll medium and restrict the roll medium in an axial direction. A plurality of engagement grooves for engaging and positioning the engagement sections of the support members are formed on the outer peripheral surface of the shaft member. Each engagement groove is formed at a position corresponding to the width size of the various roll medium.

By changing the engagement position of the engagement section of each support member with respect to each engagement groove of the shaft member, the attaching position of each support member in the axial direction with respect to the shaft member is changed. Accordingly, even when the width size of the roll medium to be replaced is different, the movement of the roll medium in the axial direction is restricted by changing the position of each support member.

It is known that the roll medium support device is provided with a lock section at a portion of the support member for supporting the core material of the roll medium. The lock section is provided so as to be movable, for example, between a position at which the protrusion bites into the inner peripheral section of the core material and a position at which the protrusion does not bite into the inner peripheral section of the core material. In this type of roll medium support device, an operation section operated by a user is provided outside the pair of support members. When the operation section is operated, the engagement of the engagement section is disengaged and becomes a position adjustment state capable of adjusting the position of the support member, or becomes an unlocked state in which the bite of the protrusion is disengaged. Accordingly, the user can replace the roll medium with respect to the roll medium support device. After the replacement of the roll medium, when another operation is performed on the operation section, the engagement section is engaged with the shaft member and becomes a positioned state in which the support member is positioned, or the state is switched to a locked state in which the protrusion bites into the inner peripheral section of the core material.

In this way, by operating the operation section, the user can perform switching between the position adjustment state and the positioned state of the support member with respect to the shaft member and switching between the locked state and the unlocked state of the roll medium with respect to the support member.

However, not only users who use various roll medium having different width sizes but also users who continue to use a roll medium having only a certain width size are not rare. Therefore, there is a need for a roll medium support device that is easy to use in accordance with the use conditions of the user.

In the roll medium support device of the related art, the empty core material is removed by operating the operation section to be in the unlocked state, but the support member may be in the position adjustment state with respect to the shaft member by the operation of the operation section at this time. As a result, the support member may be displaced in the axial direction of the shaft member in the operation of replacing the roll medium. Therefore, for users who use only roll medium of a certain width size, it is necessary to align each time, there is a problem that usability is poor. There is a demand for a roll medium support device that enables the user to easily and reliably replace the roll medium.

### SUMMARY

To solve the above described problems, a printing device includes a roll medium support device configured to support a roll medium in which a medium is wound in a roll shape and a printing section configured to print on the medium transported from the roll medium support device, wherein the roll medium support device includes a shaft member that is inserted into the roll medium, in which the medium is wound in a roll shape, along an axial line of the roll medium, a support member that includes an insertion hole into which the shaft member is insertable and an engagement section engageable with the shaft member, that is configured to move with respect to the shaft member in an extending direction of the shaft member, and that is configured to support the roll medium from the extending direction of the shaft member, a lock section that is configured to contact an inner peripheral section of the roll medium and that is configured to fix the roll medium in place, an operation section configured to allow user operation, and an auxiliary member configured to be attachable to and detachable from the support member, the operation section performs, by an operation from a first operation position to a second operation position being performed when the auxiliary member is not attached to the support member, switching from a position adjustment state in which movement of the support member with respect to the shaft member is allowed in the extending direction of the shaft member to a positioned state in which movement of the support member with respect to the shaft member in the extending direction of the shaft member is limited and, in conjunction, switching from an unlocked state in which the lock section does not contact the inner peripheral section of the roll medium to a locked state in which the lock section contacts the inner peripheral section of the roll medium, and by being attached to the support member, the auxiliary member sets the support member into the positioned state even when the operation section is in the first operation position.

To solve the above problem, a roll medium support device for supporting a roll medium in which a medium is wound in a roll shape, the roll medium support device includes a shaft member that is inserted into the roll medium, in which the medium is wound in a roll shape, along an axial line of the roll medium; a support member that includes an insertion hole into which the shaft member is insertable and an engagement section engageable with the shaft member, that is configured to move with respect to the shaft member in an extending direction of the shaft member, and that is configured to support the roll medium from the extending direction of the shaft member; a lock section that is configured to contact an inner peripheral section of the roll medium and that is configured to fix the roll medium in place; and an operation section that is configured to allow user operation and that, by an operation from a first operation position to a second operation position being performed when an auxiliary member, which is configured to be attachable to and detachable from the support member, is not attached to the support member, performs switching from a position adjustment state in which movement of the support member with respect to the shaft member is allowed in the extending direction of the shaft member to a positioned state in which movement of the support member with respect to the shaft member in the extending direction of the shaft member is limited and, in conjunction, switching from an unlocked state in which the lock section does not contact the inner peripheral section of the roll medium to a locked state in which the lock section contacts the inner peripheral section of the roll medium, wherein by the auxiliary member being attached, the support member is in the positioned state even when the operation section is in the first operation position.

To solve the above problem, an auxiliary member attached to a roll medium support device for supporting a roll medium in which a medium is wound in a roll shape, the roll medium support device including a shaft member that is inserted into the roll medium, in which the medium is wound in a roll shape, along an axial line of the roll medium; a support member that includes an insertion hole into which the shaft member is insertable and an engagement section engageable with the shaft member, that is configured to move with respect to the shaft member in an extending direction of the shaft member, and that is configured to support the roll medium from the extending direction of the shaft member; a lock section that is configured to contact an inner peripheral section of the roll medium and that is configured to fix the roll medium in place; and an operation section that is configured to allow user operation and that, by an operation from a first operation position to a second operation position being performed when the auxiliary member is not attached to the support member, performs switching from a position adjustment state in which movement of the support member with respect to the shaft member is allowed in the extending direction of the shaft member to a positioned state in which movement of the support member with respect to the shaft member in the extending direction of the shaft member is limited by engagement of the shaft member and the engagement section and, in conjunction, switching from an unlocked state in which the lock section does not contact the inner peripheral section of the roll medium to a locked state in which the lock section contacts the inner peripheral section of the roll medium, wherein the auxiliary member includes an auxiliary restriction section that is configured to be attachable to and detachable from the support member and that, by being attached to the support member, restricts the displacement amount in a direction in which the engagement section is disengaged from the shaft member to be equal to or less than the displacement amount in which the engagement between the engagement section and the shaft member is not disengaged, and the auxiliary member sets the support member into the positioned state even when the operation section is in the first operation position.

### BRIEF DESCRIPTION OF THE DRAWINGS

FIG. 1 is a perspective view showing a printing device according to an embodiment.

FIG. 2 is a perspective view showing a state where a drawer member is drawn out in the printing device.

FIG. 3 is a cross-sectional schematic view of the printing device.

FIG. 4 is a perspective view of a roll medium support device.

FIG. 5 is a cross-sectional view showing a portion of the roll medium support device, and when the operation section is in a position adjustment operation position.

FIG. 6 is a cross-sectional view showing a portion of the roll medium support device, and when the operation section is in a position determined operation position.

FIG. 7 is a partially cutaway front view showing the position of a cam when the operation section is pulled up and is in the position adjustment operation position.

FIG. 8 is a partially cutaway front view showing the position of the movable member when the operation section is pulled up and is in the position adjustment operation position.

FIG. 9 is a partially cutaway front view showing the position of the cam when the operation section is folded down and is in the position determined operation position.

FIG. 10 is a partially cutaway front view showing the position of the movable member when the operation section is folded down and is in the position determined operation position.

FIG. 11 is a front cross-sectional view showing the roll medium support device in a state in which an auxiliary member is inserted.

FIG. 12 is a perspective view of the auxiliary member as viewed from the front side.

FIG. 13 is a perspective view of the auxiliary member as viewed from the rear side.

FIG. 14 is a front cross-sectional view showing a main part of the roll medium support device showing a state in which the auxiliary member is attached to a support member.

FIG. 15 is a schematic cross-sectional view for explaining the procedure of replacement the roll medium using the auxiliary member.

FIG. 16 is a schematic cross-sectional view for explaining the procedure of replacing the roll medium using the auxiliary member.

FIG. 17 is a schematic cross-sectional view for explaining the procedure of replacing the roll medium using the auxiliary member.

### DESCRIPTION OF EMBODIMENTS

An embodiment of the printing device will be described below with reference to the drawings.

### Configuration of Printing Device 11

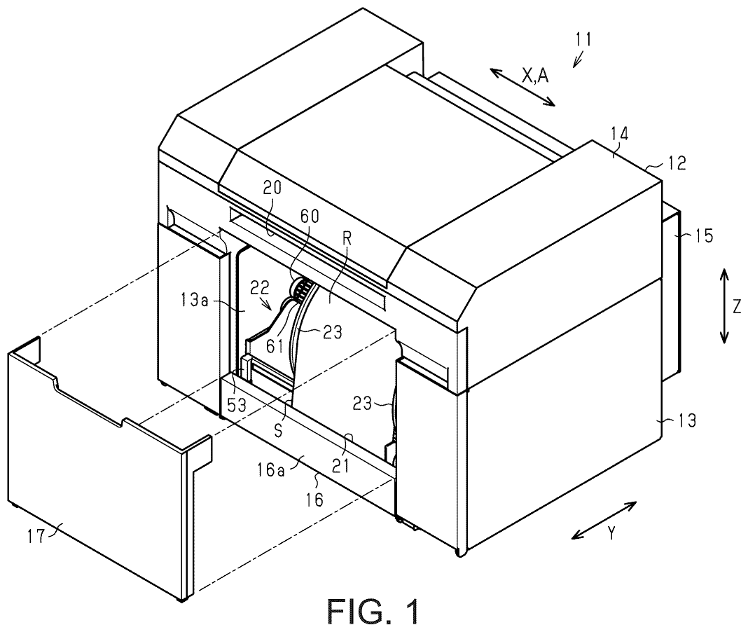

As shown in FIG. 1, the printing device 11 is an inkjet type printer. The printing device 11 includes a device main body 12 having a substantially rectangular box shape. The device main body 12 includes a first housing section 13, a second housing section 14 disposed on the upper side of the first housing section 13, and a third housing section 15 disposed on the rear side of the first housing section 13. Note that in the present embodiment, the direction along a vertical direction is referred to as a Z direction, and the direction along a front-rear direction of the printing device 11 is referred to as a Y direction. An X direction orthogonal to both the Z direction and the Y direction is defined as a width direction. The width direction X of the printing device 11 is also the width direction of a roll medium R.

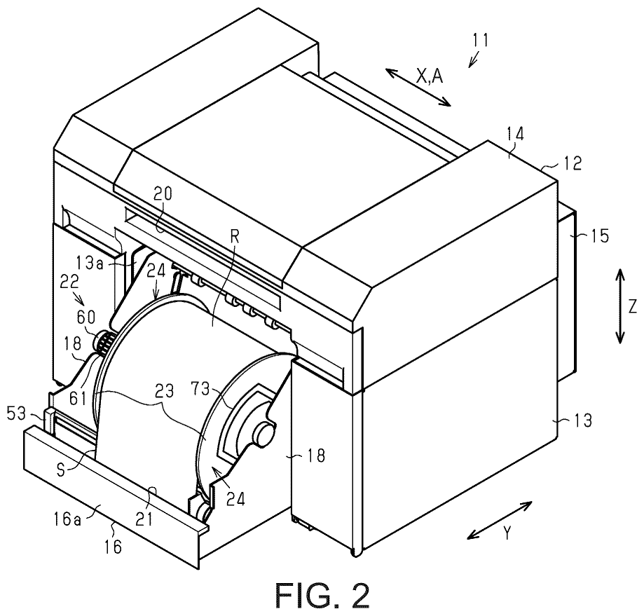

As shown in FIG. 1, a substantially rectangular plate-shaped front cover 17 is atachaly and detachably mounted on the upper side of a front plate section 16a of the first housing section 13. The printing device 11 includes a roll medium support device 22 that supports the roll medium R on which a medium S is wound in a roll shape. The roll medium support device 22 is housed in the lower portion of the device main body 12. When the medium S of the roll medium R runs out due to printing or when replaced with a different type of medium S, the roll medium support device 22 is drawn out from the housed position shown in FIG. 1 to the front of the device main body 12 as shown in FIG. 2.

First, a configuration of the device main body 12 in which the roll medium support device 22 is drawable storage will be described with reference to FIGS. 1 and 2. In the first housing section 13 of the device main body 12, a housing chamber 13a is formed in the central portion of the width direction X. In the housing chamber 13a, a drawer member 16 is housed so as to be able to be drawn out. The drawer member 16 has the rectangular front plate section 16a elongated in the width direction X at a lower portion of the front surface of the drawer member 16. When the drawer member 16 is in the housed position (position shown in FIG. 1) housed in the device main body 12 (housing chamber 13a), the front plate section 16a is exposed on the front surface side of the first housing section 13.

The drawer member 16 is configured to house the roll medium R in which the elongated medium S is wound in a roll shape. On the rear side of the front plate section 16a of the drawer member 16, an insertion port 21 for inserting the medium S unwound from the roll medium R housed in the drawer member 16 is opened.

As shown in FIG. 2, the roll medium support device 22 includes a shaft member 60 and a pair of support members 23 for supporting the roll medium R from both sides of an extending direction A of the shaft member 60. The roll medium support device 22 is mainly composed of three parts, including the shaft member 60 and a pair of support units 24 that are attachably and detachably configured with respect to the shaft member 60. The pair of support units 24 each includes the support member 23. Note that the extending direction A is equal to the width direction X in a state where the roll medium support device 22 is set in the device main body 12.

The drawer member 16 pivotably supports the roll medium support device 22 that supports the roll medium R. The roll medium support device 22 is a roll support reel configured to hold the roll medium R. When the roll medium R is set in the device main body 12, first, the drawer member 16 at a housed position (position shown in FIG. 1) is drawn out from the housing chamber 13a toward the front to the drawn out position (position shown in FIG. 2).

In this state, the roll medium R is mounted on the roll medium support device 22, and the roll medium support device 22 is supported by the drawer member 16. The roll medium support device 22 is supported by the shaft member 60 in a rotatable state with respect to the drawer member 16. Next, the leading end portion of the medium S unwound from the roll medium R is inserted into the insertion port 21. Thereafter, the drawer member 16 is pushed from the drawn out position to the housed position in the housing chamber 13a. Thus, the setting of the roll medium R in the device main body 12 is completed.

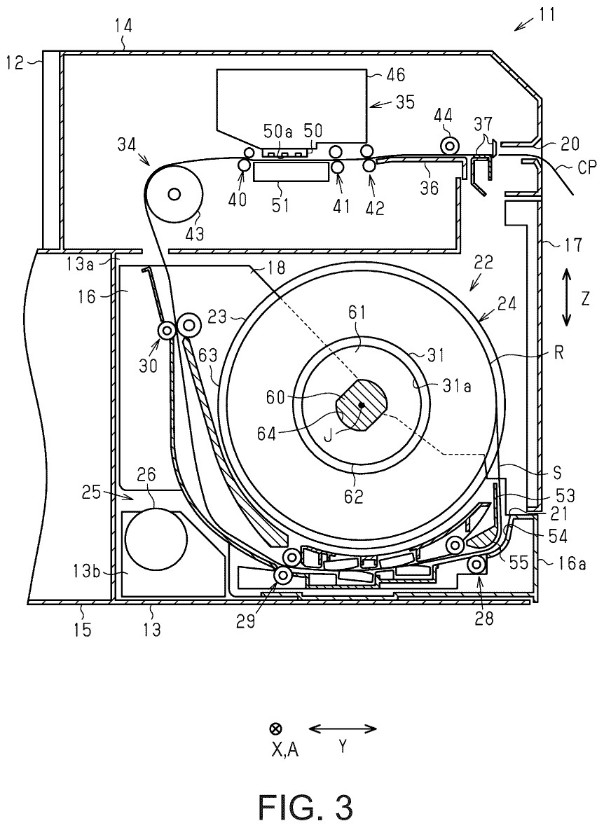

As shown in FIGS. 2 and 3, the drawer member 16 has a pair of side plate sections 18 at both end portions in the width direction X. On the front end of each side plate section 18, the left and right end portions of the front plate section 16a are respectively fixed in place. The shaft member 60 of the roll medium support device 22 is supported by the pair of side plate sections 18.

As shown in FIG. 2, the roll medium support device 22 has a gear section 61 at one end of the shaft member 60. In a state in which the roll medium support device 22 is housed in the housed position, the gear section 61 meshes with a gear mechanism (not shown) on the device main body 12 side. By power transmitted from a motor 26 in the device main body 12 (see FIG. 3) to the gear section 61 via a gear mechanism, the roll medium support device 22 rotates in the direction of feeding out the medium S together with the shaft member 60.

As shown in FIG. 3, the roll medium R includes a cylindrical core material 31 and a roll section RS formed by winding the elongated medium S around the outer peripheral of the core material 31. The support member 23 includes a cylindrical support section 62 that supports an inner peripheral section 31a of the core material 31. An outer diameter of the support section 62 is slightly smaller than an inner diameter of the inner peripheral section 31a of the core material 31.

The support member 23 is movable with respect to the shaft member 60 in the extending direction A of the shaft member 60 is configured to support the roll medium R from the extending direction A of the shaft member 60. The support member 23 includes a flange section 63 capable of supporting the roll section RS of the roll medium R supported by the support section 62 in the extending direction A. The pair of flange sections 63 are arranged so as to sandwich from both left and right sides the roll medium R into which the shaft member 60 is inserted. The flange section 63 has a substantially disc shape. In a state where the pair of support units 24 are positioned with respect to the shaft member 60, the roll section RS is sandwiched from both sides in the extending direction A by the pair of flange sections 63.

The shaft member 60 is inserted into the roll medium R in which the medium S is wound in a roll shape along an axial line J (axial center) of the roll medium R. In a state where the inner peripheral section 31a of the core material 31 is supported by the support section 62, the axial line J of the roll medium R coincides with the axial line J of the shaft member 60. The support member 23 has an insertion hole 64 through which the shaft member 60 can be inserted.

A fixing frame 13b is arranged at the back side of the drawer member 16 at the bottom of inside the housing chamber 13a. On one end side of the fixing frame 13b and the drawer member 16 in the width direction X, a transport device 25 for transporting (feeding) the medium S unwound from the roll medium R toward the second housing section 14 side is disposed. The motor 26 serves as a drive source for the transport device 25, the roll medium support device 22, and the like is fixed to the fixing frame 13b.

As shown in FIG. 3, the drawer member 16 includes a path forming member 53 which forms the insertion port 21 between the path forming member 53 and the front plate section 16a. The medium S unwound from the roll medium R is guided through between a path forming section 55 which is curved in the convex shape of the path forming member 53 and a path forming section 54 which is curved in the concave shape of the front plate section 16a. Transport roller pairs 28 and 29 are disposed downstream the path forming sections 54 and 55 on the transport path at predetermined intervals. By the transport roller pairs 28 and 29 are rotationally driven by the driving force of the motor 26, transporting the medium S along the transport path.

The transport device 25 transports the medium S to the downstream side along the transport path formed in the drawer member 16. The medium S transported by the transport device 25 is guided by a transport roller pair 30 provided in an upper portion of the drawer member 16 and is sent into the second housing section 14 positioned above.

A transport mechanism 34 is provided in the second housing section 14. The transport mechanism 34 includes an intermediate roller 43, transport roller pairs 40, 41, and 42, and a discharge roller 44. Further, a discharge port 20 is formed in the front surface of the second housing section 14 at a position above the housing chamber 13a. The transport mechanism 34 transports the medium S transported from the roll medium support device 22 toward the discharge port 20 in a transport direction Y.

The printing device 11 includes a printing section 35 that performs printing on the medium S transported from the roll medium support device 22. The printing section 35 performs printing by ejecting a liquid such as ink onto the medium S transported in the transport direction Y by the transport mechanism 34. The printing section 35 has a carriage 46 disposed to enable reciprocate movement in the width direction X, and a print head 50 supported at a lower portion of the carriage 46. A support base 51 for supporting the medium S at a position between the transport roller pair 40 and the transport roller pair 41 is disposed below a movement path of the carriage 46 during printing. On the lower surface of the print head 50, a plurality of nozzles 50a for ejecting the ink as an example of the liquid are opened.

A heater 36 which dries the medium S to which the ink is deposited and a cutter 37 which cuts the dried medium S are housed in the second housing section 14. The medium S on which printing has been performed is dried by being transported along the upper surface of the plate-shaped heater 36. The printed portion of the dried medium S that has passed over the heater 36 is cut into unit lengths by the cutter 37 to form a cut paper sheet CP. Then, the cut paper sheet CP is discharged outside the device main body 12 through the discharge port 20.

### Configuration of Roll Medium Support Device 22

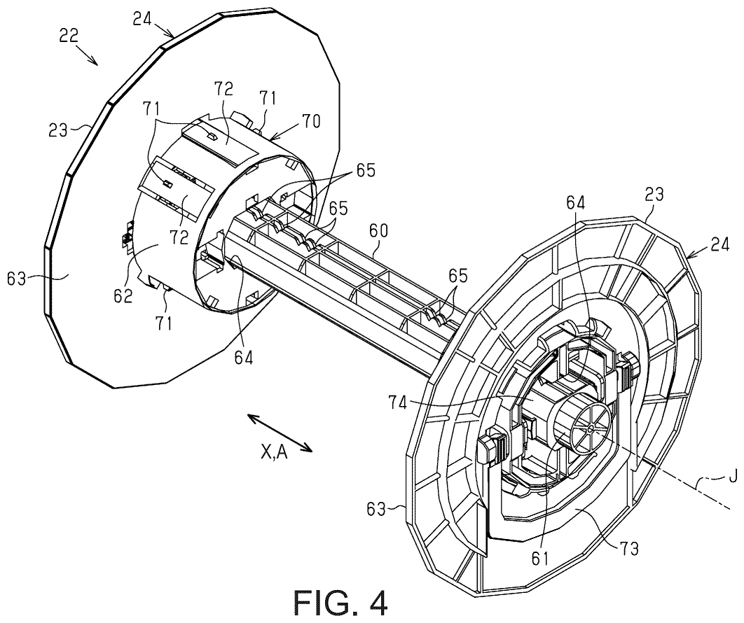

Next, the configuration of the roll medium support device 22 will be described in detail with reference to FIG. 4. The roll medium support device 22 shown in FIG. 4 includes the shaft member 60 and the pair of support units 24 as described above. Two support members 23 are provided corresponding to both sides of the width direction X of the roll medium R (extending direction A of the shaft member 60).

The shaft member 60 has the gear section 61 at one end in the extending direction A of the shaft member 60. The support unit 24 includes a lock section 70 and an operation section 73 in addition to the support member 23. That is, the roll medium support device 22 includes one shaft member 60, two support members 23, two lock sections 70, and two operation sections 73. The operation section 73 is configured to enable operation by the user and is provided at the outer surface of the support member 23 in a state enabling an operation of pivoting in a predetermined angular range around the pivot axis, which is perpendicular to the axial line J of the shaft member 60.

The lock section 70 is provided on an outer peripheral section of the support section 62. The lock section 70 includes at least one protrusion 71 and a plate-shaped displacing member 72 formed with the protrusion 71. In the example shown in FIG. 4, the lock section 70 has a plurality (for example, 6) of protrusions 71. The protrusion 71 protrudes from the outer surface of the plate-shaped displacing member 72, which is formed so as to be displaceable in a radial direction of the support section 62. The displacing member 72 includes a cantilevered rectangular arm section that is formed to be displaceable in the radial direction by, for example, a part of the outer peripheral section of the support section 62 being in a connected state at one side and being notched at the other three sides. The lock section 70 has, for example, the protrusion 71 on the upper surface of the arm section constituting the displacing member 72.

In a state in which the displacing member 72 can be displaced inward in the radial direction of the support section 62, since the protrusion 71 is retracted when the roll medium R is supported by the support section 62, the user can attach and detach the roll medium R to and from the support section 62. That is, the roll medium R can be attached to and detached from the support section 62 in the unlocked state (lock release state) in which the protrusion 71 can escape inward in the radial direction. On the other hand, the lock section 70 is configured to contact the inner peripheral section 31a of the roll medium R and is configured to fix the roll medium R. The lock section 70 locks the core material 31 of the roll medium R with respect to the support section 62 by the plurality of protrusions 71 by displacing the plurality of protrusions 71 outward in the radial direction of the support section 62. The lock section 70 is driven in conjunction with the operation of the operation section 73 by the user, and is switchable between the locked state for fixing the roll medium R in place with respect to the support section 62 and the unlocked state in which the roll medium R can be attached to and detached from the support section 62.

As shown in FIG. 4, the shaft member 60 has a plurality of engagement grooves 65 at a plurality of positions separated by a predetermined interval along the extending direction A. The engagement grooves 65 are provided at positions corresponding to width sizes, which are the dimension of roll mediums R in the width direction X. The support member 23 (that is, the support unit 24) is positioned at a position corresponding to the width size of the roll medium R with respect to the shaft member 60 by being engaged with the engagement groove 65 that corresponds to the width size of the roll medium R. In conjunction with the operation of the operation section 73, switching between engagement and disengagement of the support member 23 with respect to the shaft member 60 is performed.

When an auxiliary member 80 (to be described later) is not attached to the support member 23, the operation section 73 can, by being operated by the user, perform switching between locking and unlocking the lock section 70 and switching between engagement and disengagement of the support member 23 with respect to the shaft member 60 in conjunction with each other. Specifically, when the auxiliary member 80 is not attached to the support member 23, the operation section 73 can, by performing an operation from a first operation position to a second operation position, perform the switching of the support member 23 from disengagement to engagement with respect to the shaft member 60 and the switching of the lock section 70 from unlocked to the locked in conjunction with each other. When the auxiliary member 80 is not attached to the support member 23, the operation section 73 can, by performing an operation from the second operation position to the first operation position, perform the switching of the support member 23 from engagement to disengagement with respect to the shaft member 60 and the switching of the lock section 70 from locked to unlocked in conjunction with each other.

The support member 23 includes a movable member 74 configured to restrict a displacement amount of an engagement section 75 in a direction in which the engagement section 75 moves away from the shaft member 60. By the operation section 73 being operated, the movable member 74 moves to a first position where the displacement amount of the engagement section 75 is allowed to be a displacement amount where the engagement between the engagement section 75 and the shaft member 60 can be disengaged. By the operation section 73 being operated, the movable member 74 moves to a second position where the displacement amount of the engagement section 75 is restrictable within a range wherein the engagement section 75 and the shaft member 60 do not disengage.

The movable member 74 is configured capable of reciprocation displacement in a direction (the extending direction A) along the axial line J of the shaft member 60 in conjunction with the operation of the operation section 73. The movable member 74, by reciprocating displacement in the extending direction A of the shaft member 60, moves to the first position and the second position. In the present embodiment, the movable member 74 is displaced in the extending direction A of the shaft member 60 via operation of the operation section 73, so that switching between engagement and disengagement of the support member 23 with respect to the shaft member 60 and switching between locking and unlocking of the lock section 70 are performed in conjunction with each other. Hereinafter, switching between engagement and disengagement of the support member 23 with respect to the shaft member 60 is also referred to as “first switching”, and switching between locking and unlocking of the lock section 70 is also referred to as “second switching”.

### Switching Operation by Operation Section 73

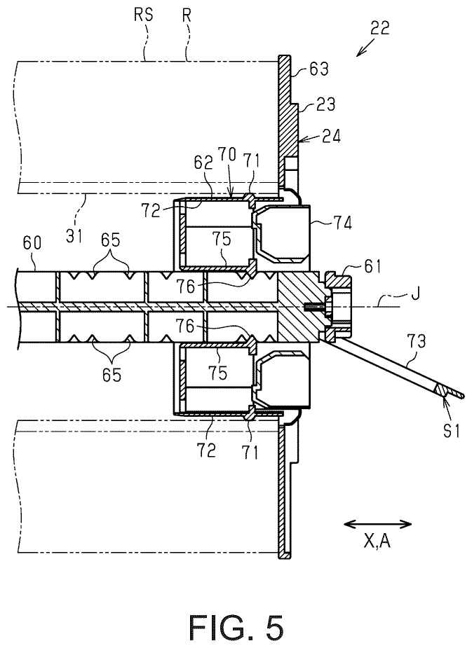

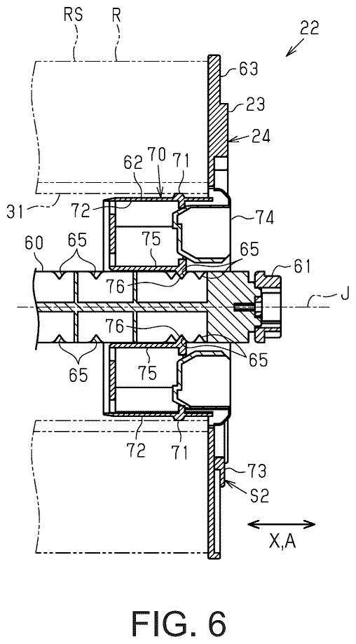

Next, the switching operation by the operation section 73 will be described with reference to FIGS. 5 and 6. The operation section 73 can be operated to a position adjustment operation position (the first operation position) S1 shown in FIG. 5 and a position determined operation position (the second operation position) S2 shown in FIG. 6. The lock section 70 and the operation section 73 are provided on the support member 23. That is, together with the support member 23, the lock section 70 and the operation section 73 are configured as the support unit 24, which is one component.

As shown in FIG. 5, in a state where the operation section 73 is pulled up to the position adjustment operation position S1, the movable member 74 is located at the first position, which is displaced toward the outer side in the extending direction A (toward the right side in FIG. 5) with respect to the shaft member 60. The movable member 74 is provided in a displaceable state in a direction parallel to the axial line J with respect to the support section 62.

The roll medium support device 22 has the engagement section 75, which is engageable with the shaft member 60. For example, a pair of engagement sections 75 are provided at two positions facing each other with the shaft member 60 interposed therebetween in a direction orthogonal to the axial line J of the shaft member 60. The engagement section 75 includes a cantilevered rectangular arm section that is formed to be displaceable in the radial direction of the support section 62 by, for example, a part of the inner peripheral section of the support section 62 being in a connected state and the other three sides being notched. The engagement section 75 has an engagement claw 76 at the tip end portion of the arm section. Note that the number of the engagement sections 75 is not limited to one pair (two) and may be three or four.

The displacing member 72 having the protrusion 71 constituting the lock section 70 is provided on the outer peripheral section of the support section 62 so as to be displaceable in the radial direction of the support section 62. By reciprocal displacement in the extending direction A of the shaft member 60 by a predetermined stroke, the movable member 74 has a function of switching between engagement and disengagement of the engagement section 75 with the engagement groove 65 and a function of switching the lock section 70 between locking and unlocking.

As shown in FIG. 5, in a state in which the operation section 73 is operated to be pulled up into the position adjustment operation position S1, the movable member 74 is disposed at the first position, which is positioned on the outer side in the extending direction A. In this state, the protrusion 71 is capable of displacement to escape inward in the radial direction of the support section 62 and the engagement section 75 is capable of displacement outward in the radial direction of the support section 62 by an amount by which the engagement claw 76 is disengaged from the engagement groove 65. Therefore, the position of the support member 23 with respect to the shaft member 60 can be adjusted and the roll medium R can be attached to and detached from the support section 62.

As shown in FIG. 6, in a state in which the operation section 73 is operated folded down to the position determined operation position S2, the movable member 74 is disposed at the second position displaced inward from the first position in the direction along the axial line J. In this state, the protrusion 71 is displaced so as to be pushed out in the radial direction of the support section 62, and also the engagement section 75 can only be displaced outward in the radial direction of the support section 62 by an amount that does not disengage the engagement claw 76 from the engagement groove 65. Therefore, the engagement claw 76 is engaged with the engagement groove 65 so that the position of the support member 23 can be set with respect to the shaft member 60, and the protrusion 71 fits into the inner peripheral section 31a of the core material 31 so that the roll medium R is fixed (locked) to the support section 62.

### Mechanism for Conjunction of Operation Section 73 and Movable Member 74

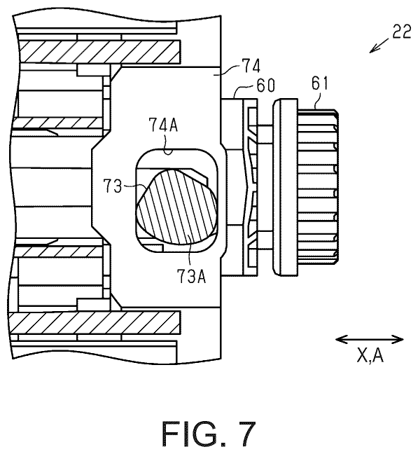

Next, a mechanism for conjunction of the operation section 73 and the movable member 74 will be described with reference to FIG. 7. As shown in FIG. 7, the operation section 73 has, at its base section, a cam body 73A inserted into a cam hole 74A, which is formed in the movable member 74. The cam body 73A is rotatable by operation of the operation section 73. A cam surface having a predetermined shape is formed on an outer peripheral surface of the cam body 73A. By rotating, the cam body 73A contacts the inner peripheral surface of the cam hole 74A and causes reciprocal displacement of the movable member 74 in the extending direction A of the shaft member 60.

When the operation section 73 is in the position adjustment operation position S1 (see FIG. 5), the cam body 73A takes a first posture shown in FIG. 7. The cam body 73A in the first posture causes the movable member 74 to be disposed at the first position by contacting the inner peripheral surface of the cam hole 74A.

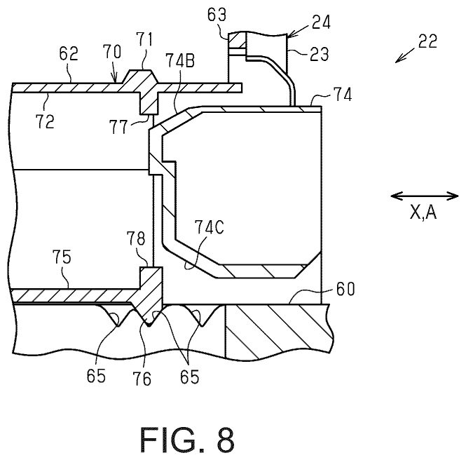

As shown in FIG. 8, the displacing member 72 constituting the lock section 70 has a first engaged section 77 protruding inward in the radial direction of the support section 62 on the surface opposite to the protrusion 71. The engagement section 75 has a second engaged section 78 that is on the surface opposite to the engagement claw 76 and that protrudes inward in the radial direction of the support section 62. In the movable member 74, a first guide surface 74B is formed at a radially outward position corresponding to the first engaged section 77, and a second guide surface 74C is formed at a radially inward position corresponding to the second engaged section 78.

As shown in FIG. 8, when the movable member 74 is in the first position, the first engaged section 77 of the lock section 70 is separated from the first guide surface 74B of the movable member 74 by a first distance or more in the radial direction of the support section 62. Therefore, the protrusion 71 of the lock section 70 can be retracted so as not to bite into the core material 31 of the roll medium R. When the movable member 74 is in the first position, the second engaged section 78 of the engagement section 75 is separated from the second the second guide surface 74C of the movable member 74 by a second distance or more in the radial direction of the support section 62. Therefore, the engagement section 75 can be displaced radially outward to a position where the engagement claw 76 can be disengaged from the engagement groove 65. Therefore, when the user applies a force to move the support member 23 in the extending direction A of the shaft member 60, it is possible to switch the engagement groove 65 that is to be the engagement partner of the engagement claw 76. The user can adjust perform position adjustment by moving the support member 23 in the extending direction A with respect to the shaft member 60.

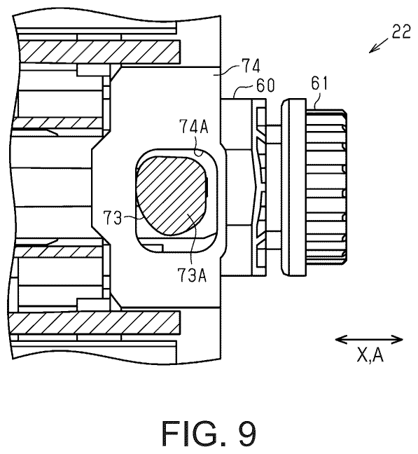

On the other hand, when the operation section 73 is in the position determined operation position S2 (see FIG. 6), the cam body 73A takes a second posture shown in FIG. 9. The cam body 73A in the second posture causes the movable member 74 to be disposed at the second position by contacting the inner peripheral surface of the cam hole 74A. The movable member 74 in the second position is displaced inward (left side in FIG. 9) in the extending direction A of the shaft member 60 than the first position.

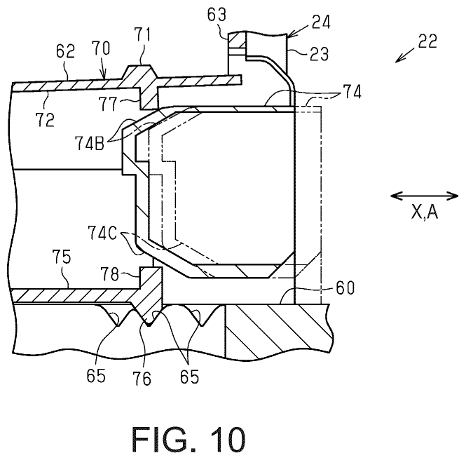

As shown in FIG. 10, when the movable member 74 is in the second position, the protrusion 71 is pushed up outward in the radial direction of the support section 62 by the first engaged section 77 of the lock section 70 contacting the first guide surface 74B of the movable member 74. Therefore, the lock section 70 protrudes radially outward to a position where the protrusion 71 bites into the core material 31 of the roll medium R. Accordingly, the roll medium R is locked with respect to the support section 62. Note that as long as the protrusion 71 can fix the roll medium R, the first guide surface 74B may not abut the first engaged section 77 when the movable member 74 is in the second position.

When the movable member 74 is in the second position, the second engaged section 78 of the engagement section 75 is positioned at a distance closer to the second guide surface 74C of the movable member 74 than the second distance in the radial direction of the support section 62. Therefore, even if the engagement section 75 is to be displaced inward in the radial direction of the support section 62, the second engaged section 78 contacts the second guide surface 74C to restrict further displacement, so that the engagement section 75 cannot be displaced radially outward to a position where the engagement section 75 can be disengaged from the engagement groove 65. That is, the position of the support member 23 with respect to the shaft member 60 is determined. Note that when the movable member 74 is in the second position, the second guide surface 74C may contact the second engaged section 78.

With the above configuration, by being operated by the user, the operation section 73 performs the first switching and the second switching in conjunction with each other. The first switching is a switch between the positioned state wherein the movement of the support member 23 with respect to the shaft member 60 is limited in the extending direction A of the shaft member 60 by engagement between the shaft member 60 and the engagement section 75 and the position adjustment state wherein movement of the support member 23 with respect to the shaft member 60 is allowed in the extending direction A of the shaft member 60. The second switching is a switch between the locked state wherein the lock section 70 contacts the inner peripheral section 31a of the core material 31 of the roll medium R and the unlocked state wherein the lock section 70 does not contact the inner peripheral section 31a of the core material 31 of the roll medium R. Note that the lock section 70 contacts the inner peripheral section 31a of the core material 31 of the roll medium R refers to contacting in a lockable manner such as contacting of the protrusion 71 or unevenness. It includes that the inner peripheral section 31a of the core material 31 contacts at a predetermined surface pressure in a lockable manner with the friction surface.

The operation section 73 is a lever. When the operation section 73 is pulled up with respect to the support member 23 as an operation to the position adjustment operation position (the first operation position) S1, it causes the support member 23 to enter into the position adjustment state with respect to the shaft member 60 and, when the operation section 73 is folded down with respect to the support member 23 as an operation to the position determined operation position (the second operation position) S2, it causes the support member 23 to enter into the positioned state with respect to the shaft member 60. Each of the two support members 23 are configured to attach the auxiliary member 80. Therefore, the user can attach the auxiliary member 80 to one of the two support members 23 that the user desires to maintain the positioned state among two of the two support members 23.

Note that switching between engagement and disengagement of the support member 23 with respect to the shaft member 60 by the operation section 73 corresponds to switching between the positioned state and the position adjustment state of the support member 23 with respect to the shaft member 60.

### Configuration of Auxiliary Member 80

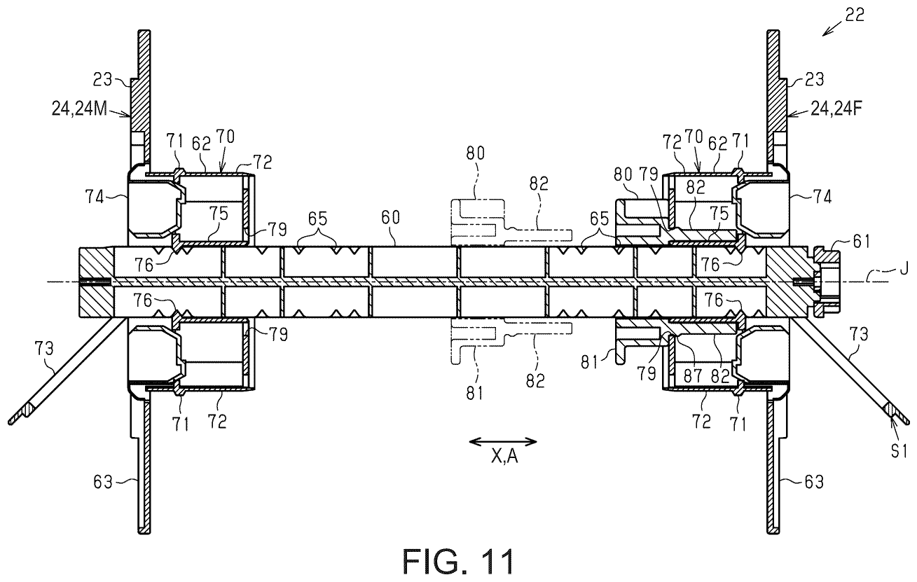

Next, configuration of the roll medium support device 22 including the auxiliary member 80 will be described with reference to FIG. 11. The roll medium support device 22 of the present embodiment includes the auxiliary member 80. The auxiliary member 80 is configured to attach to and detach from the support member 23. By the auxiliary member 80 being attached to the support member 23, the auxiliary member 80 places the support member 23 into the positioned state even when the operation section 73 is in the position adjustment operation position S1.

The auxiliary member 80 is configured to enable insertion of the shaft member 60. The auxiliary member 80 is a member independent of the support member 23. By the auxiliary member 80, in a state of have the shaft member 60 inserted into it, being attached at an attached position, which corresponds to the engagement section 75 with respect to the support member 23 through the shaft member 60 has been inserted, the auxiliary member 80 restricts the displacement amount of the engagement section 75 in the direction in which engagement between the engagement section 75 and the shaft member 60 disengages, within a range in which they do not disengage.

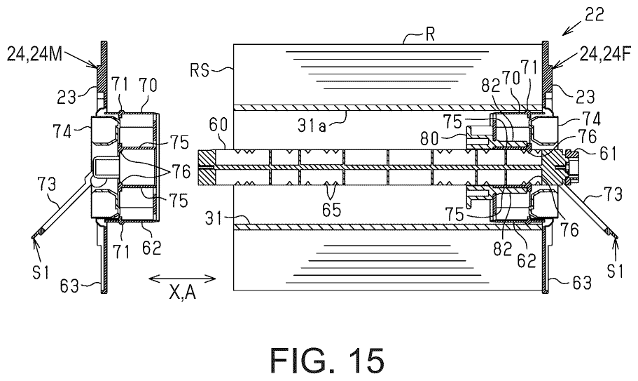

The auxiliary member 80 has an outer diameter smaller than an outer diameter of the cylindrical support section 62 for supporting the roll medium R by the support member 23. In other words, the auxiliary member 80 has an outer diameter smaller than the inner diameter of the inner peripheral section 31a of the core material 31 of the roll medium R (see FIG. 15 and the like). As shown in FIG. 11, the auxiliary member 80 is attached to the support member 23 from the inside in the width direction X of the roll medium R (the extending direction A of the shaft member 60).

The auxiliary member 80 includes a base section 81 into which the shaft member 60 is inserted and an auxiliary restriction section 82 that extends from the base section 81 and that restricts the displacement amount of the engagement section 75 within a range in which the engagement is not disengaged. When the auxiliary restriction section 82 is attached to an attachment section 79 of the support member 23, the auxiliary restriction section 82 restricts the displacement amount of the engagement section 75 within a range in which the engagement section 75 does not disengage to a position different from the position where the movable member 74 restricts the displacement amount of the engagement section 75. The auxiliary member 80 includes, for example, the same number of auxiliary restriction sections 82 as the engagement sections 75. In the example of the auxiliary member 80 shown in FIG. 11, two auxiliary restriction sections 82 are provided. The two auxiliary restriction sections 82 extend with respect to the base section 81 in a direction parallel to the axial line J from positions on both sides that sandwich the axial line J.

The support member 23 has the attachment section 79 on the end surface of the inner side of the support section 62 (left side in FIG. 11). Two attachment sections 79 are provided at positions corresponding to the two engagement sections 75. By the auxiliary restriction sections 82 of the auxiliary member 80 being attached in the attachment sections 79 of the support member 23, the auxiliary restriction section 82 restricts the displacement of the engagement section 75 in the radial direction of the support section 62. Therefore, by the auxiliary restriction section 82 restricting the engagement section 75 to a position for engaging with the shaft member 60, the support member 23 and the shaft member 60 are in a positioned state.

In this way, the auxiliary restriction section 82 restricts the engagement section 75 from being displaced outward in the radial direction of the engagement section 75 of the support section 62 to a position where the engagement claw 76 is disengaged from the engagement groove 65. As a result, the state in which the engagement claw 76 is engaged with the engagement groove 65 is maintained regardless of the operating position of the operation section 73. That is, regardless of the operation position of the operation section 73, the positioned state in which the movement of the support member 23 with respect to the shaft member 60 is restricted is maintained.

The auxiliary member 80 includes a disengagement restriction section 87 that restricts movement in the direction that would cause disengagement from the attaching position where the auxiliary restriction section 82 is attached to the attachment section 79 of the support member 23. The auxiliary restriction section 82 may be configured to be temporarily fitted at least in a process in which the disengagement restriction section 87 passes through the attachment section 79. In a state where the auxiliary restriction section 82 is attached to the attachment section 79, there may be a gap between the auxiliary restriction section 82 and the engagement section 75. In short, it is sufficient that displacement of the engagement section 75 outward in the radial direction of the support section 62 can be restricted by the auxiliary restriction section 82 to an extent that the engagement claw 76 does not disengage from the engagement groove 65.

In the following description, one of the support units 24 among the pair of support units 24 on the side where the auxiliary member 80 is attached to the support member 23 is also referred to as a “fixed side support unit 24F”. The other support unit 24 on the side where the auxiliary member 80 is not attached to the support member 23 is also referred to as “movable side support unit 24M”.

The plurality of pairs of engagement grooves 65 shown in FIG. 11 are formed at a plurality of positions including positions at the width sizes of the roll mediums R, for example, roll mediums R that have width sizes of 3.5 inches wide, 4 inches wide, 6 inches wide, 8 inches wide, A4 width, 8.5 inch width, can be supported. The engagement claws 76 are engaged with the pair of engagement grooves 65 corresponding to the width size of the roll medium R supported by the support member 23 among the plurality of pairs of engagement grooves 65. As shown in FIG. 11, the fixed side support unit 24F to which the auxiliary member 80 is attached is maintained in a state in which the engagement claws 76 are engaged with the engagement grooves 65, regardless of the operation position of the operation section 73, and thus is maintained in the positioned state in which the auxiliary member 80 is attached at a predetermined position with respect to the shaft member 60.

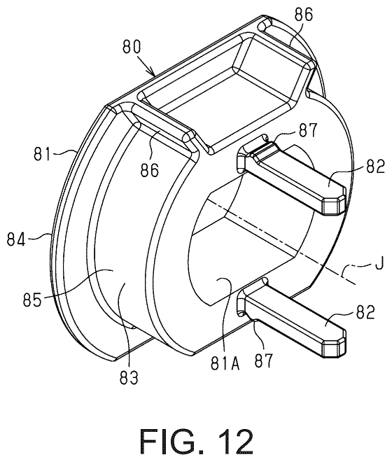

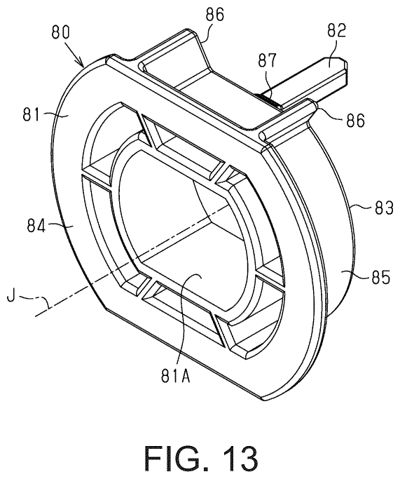

Next, a detailed configuration of the auxiliary member 80 will be described with reference to FIGS. 12 and 13. As shown in FIGS. 13 and 12, the auxiliary member 80 includes the base section 81 through which the shaft member 60 is inserted and the auxiliary restriction section 82 that extends from the base section 81 and that is configured to, when the auxiliary member 80 is attached to the attachment section 79 of the support member 23, restrict the displacement amount of the engaging section 75 within a range in which the engagement section 75 is not disengaged at a position different from the position at which the movable member 74 restricts the displacement amount of the engagement section 75.

The base section 81 includes an annular section 83 and a back plate section 84 having a flange-shape and extending in the direction along the axial line J with respect to the annular section 83 over the entire circumference in the radial direction at an end section opposite to the auxiliary restriction section 82. The two auxiliary restriction sections 82 extend from one end surface of the annular section 83 by predetermined lengths along a direction parallel to the axial line J from positions opposed to each other across a hole 81A.

The annular section 83 includes an annular main body section 85 and a plurality of reinforcing ribs 86 that extend radially outward from an outer peripheral surface of the main body section 85. The disengagement restriction section 87 is formed near the base portion of the auxiliary restriction section 82. The disengagement restriction section 87 may be, for example, a protrusion, as long as it has a detachment preventing function. Note that although the number of the auxiliary restriction sections 82 of the auxiliary member 80 is two, it may be a plural number equal to or less than the number of the engagement sections 75. For example, the number of engagement sections 75 may be three, and the number of auxiliary restriction sections 82 of the auxiliary member 80 may be two or three.

As shown in FIGS. 12 and 13, the cross-sectional shape cut in a virtual plane perpendicular to the axial line J of the hole 81A is substantially the same as the cross-sectional shape cut in a virtual plane perpendicular to the axial line J of the shaft member 60. For example, the inner peripheral surface of the hole 81A is formed by a pair of plane surfaces and a pair of arcuate surfaces facing each other. Due to the cross-sectional shape of the hole 81A, the auxiliary member 80 has a rotation-stop function in a state in which the shaft member 60 is inserted into the hole 81A.

Therefore, as shown in FIG. 11, the auxiliary member 80 is disposed in a predetermined orientation in the rotational direction around the axial line J with respect to the shaft member 60 inserted through the hole 81A. In a state where the shaft member 60 is inserted into the hole 81A of the auxiliary member 80, the auxiliary member 80 is held in a posture in which the two auxiliary restriction sections 82 face the pair of attachment sections 79, which open up at the end surface of the support section 62 in the extending direction A of the shaft member 60. Therefore, the user can attach the two auxiliary restriction sections 82 into the attachment sections 79 of the support section 62 by moving the auxiliary member 80, into which the shaft member 60 has been inserted, along the shaft member 60 toward the one support member 23 to which the user wants to attach the auxiliary member 80. In the example shown in FIG. 11, the attachment section 79 serves as an insertion port into which the auxiliary restriction section 82 is inserted, and the auxiliary restriction section 82 of the auxiliary member 80 is inserted into the insertion port. Note that the insertion into the insertion port of the auxiliary restriction section 82 may be a fit against the surface of the engagement section 75, it may be an insertion into the engagement section 75 with a predetermined gap. The attachment section 79 may not have an opening such as an insertion port and may be, for example, a gap or an indented portion for attachment which is formed in an attachment portion.

### Positioning Function by Auxiliary Member 80

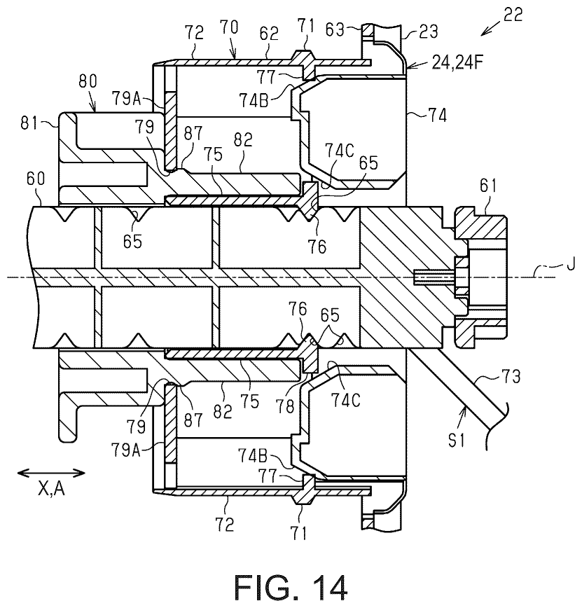

Next, the positioning function of the auxiliary member 80 will be described with reference to FIG. 14. As shown in FIG. 14, the auxiliary restriction section 82 of the auxiliary member 80 is inserted from the attachment section 79 to a position on the rear surface side of the engagement section 75. By the auxiliary restriction section 82 being disposed on the rear side of the engagement section 75, the amount that the engagement section 75 can move in the direction of disengagement is limited. Therefore, the engagement between the engagement claw 76 and the shaft member 60 is maintained. That is, the position of the support unit 24F with respect to the shaft member 60 is fixed.

The attachment section 79 of the support section 62 is slightly narrower in the radial direction than the thickness of the portion that is the disengagement restriction section 87 of the auxiliary restriction section 82. Therefore, when the disengagement restriction section 87 is attached to a position deeper than the attachment section 79, the disengagement restriction section 87 engages with a member 79A, which forms the attachment section 79, and functions as a retainer. As shown in FIG. 12, the front and rear of the disengagement restriction section 87 in the insertion direction are inclined surfaces. Therefore, if the user applies a slight force, it is possible to relatively easily insert and remove the auxiliary restriction section 82 of the auxiliary member 80 with respect to the attachment section 79.

### Operations of Embodiment

Next, the operation of the printing device 11 and the roll medium support device 22 configured as described above will be described.

When the medium S runs out during printing or the medium S to be printed is changed, the roll medium R is replaced. First, the drawer member 16 is drawn out from the housed position (position shown in FIG. 1) to the drawn out position (position shown in FIG. 2). Subsequently, the roll medium support device 22 is removed from the drawer member 16.

Subsequently, the empty core material 31 attached to the roll medium support device 22 is replaced with the new roll medium R. First, the operation sections 73 are operated on both sides of the roll medium support device 22 from the position determined operation position S2 to the position adjustment operation position S1. For example, in a case where the auxiliary member 80 is not attached to the support member 23, when the movable member 74 is displaced from the second position to the first position in conjunction with the operation of the operation section 73, the engagement between the engagement section 75 and the shaft member 60 is released, and the lock of the roll medium R by the lock section 70 is released. Then, the user removes the support units 24 on both sides from the shaft member 60 and also removes the empty core material 31 from the support member 23. Next, the new roll medium R is set to the roll medium support device 22.

When the operation section 73 is pulled up in a state in which the auxiliary member 80 is not attached, the support member 23 changes from the positioned state to the position adjustment state, and thus the support member 23 moves with respect to the shaft member 60. In this case, if the roll medium R to be replaced has the same width size, the position of one support unit 24 with respect to the shaft member 60 may remain the same. However, when the operation section 73 is operated to the position adjustment operation position S1, the position of the support unit 24 with respect to the shaft member 60 is shifted. It is necessary to align both support units 24 with respect to the shaft member 60.

In a case where the width size of the roll medium R is different before and after the replacement, the positions of the support units 24 on both sides are adjusted with respect to the shaft member 60 according to the width size, and thus there is no problem even when the position of the support member 23 with respect to the shaft member 60 is shifted. However, depending on the user, only the roll medium R having the same width size may be replaced at all times or for a predetermined period. In this case, the user attaches the auxiliary member 80 to the roll medium support device 22.

For example, the auxiliary member 80 is attached to one support unit 24 on the side of the pair of support members 23 on which it is desired to maintain the positioned state. The user attaches the auxiliary member 80 with the shaft member 60 inserted through the hole 81A of the base section 81 to the attachment section 79 of the support member 23 through which the shaft member 60 has been inserted. More specifically, the auxiliary restriction section 82 extending from the base section 81 of the auxiliary member 80 is inserted and attached to, for example, an insertion port of the attachment section 79 of the support member 23.

As shown in FIG. 14, each of the auxiliary restriction sections 82 attached to the attachment sections 79 are arranged in a state of being in contact, or adjacent with a slight gap with a back surface which is a surface opposite to a surface on a side on which the engagement claw 76 is provided with respect to each of the engagement sections 75. As a result, the displacement amount in a direction where the engagement section is disengaged of each engagement section 75 is restricted to a value within a range in which the engagement section 75 is not disengaged by the auxiliary restriction section 82 disposed on the back surface side. Thus, the position of the fixed side support unit 24F with respect to the shaft member 60 is maintained in the positioned state regardless of the operation position of the operation section 73.

The replacement of the roll medium R in the roll medium support device 22 in which the auxiliary member 80 is attached to the support member 23 is performed as follows.

As shown in FIG. 15, the operation section 73 is pulled up when the roll medium R is replaced. That is, the user operates the operation section 73 to the position adjustment operation position S1 shown in FIG. 15. Then, in conjunction with the operation of the operation section 73, the movable member 74 is displaced from the second position to the first position. However, in the fixed side support unit 24F to which the auxiliary member 80 is attached, since auxiliary restriction section 82 of the auxiliary member 80 restricts the displacement amount in a direction where the engagement section is disengaged of the engagement section 75 is disengaged, the engagement section 75 is maintained in a state of being engaged with the engagement groove 65. In other words, the support member 23 is maintained in the positioned state with respect to the shaft member 60.

As shown in FIG. 15, the user detaches the support member 23 of movable side to which the auxiliary member 80 is not attached from the shaft member 60, and mounts the new roll medium R to the shaft member 60 from that side. The support section 62 of the support member 23 on the fixed side causes the insertion of the core material 31 of the roll medium R. At this time, since the support member 23 of the fixed side is fixed with respect to the shaft member 60, the support member 23 of the fixed side positional deviation with respect to the shaft member 60 does not occur.

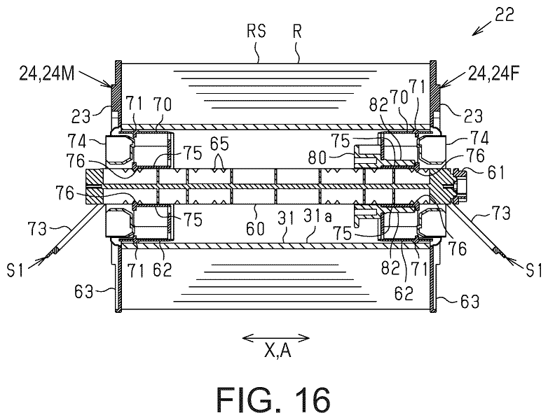

Next, as shown in FIG. 16, the movable side support unit 24M is inserted into the shaft member 60. At this time, the user inserts the support section 62 of the support member 23 on the movable side into the core material 31 of the roll medium R. Thus, as shown in FIG. 16, the roll medium R is mounted in a positionally adjusted state with respect to the roll medium support device 22.

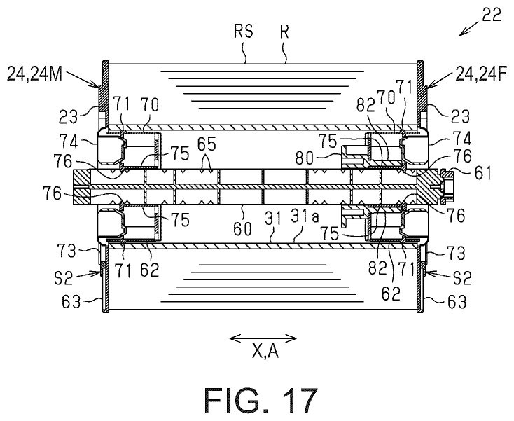

Next, as shown in FIG. 17, the user performs an operation to fold down the operation section 73 from the position adjustment operation position S1 to the position determined operation position S2. By this operation, the movable member 74 is displaced from the first position to the second position. By the first guide surface 74B of the movable member 74 presses the first engaged section 77, the protrusion 71 bites into the inner peripheral section 31a of the core material 31. As a result, the roll medium R is locked to the support section 62 of the support member 23. At the same time, the second guide surface 74C of the movable member 74 limits the amount that the second engaged section 78 can be displaced radially outward. Thus, the position of the extending direction A of the support member 23 with respect to the shaft member 60 is positioned. In this way, since it is not necessary to position the one support unit 24F each time, usability is improved for the user who uses only the roll medium R having a constant width size.

According to the embodiment described in detail above, the following effects can be obtained.

(1) The printing device 11 includes the roll medium support device 22 configured to support the roll medium R in which the medium S is wound in a roll shape and the printing section 35 configured to print on the medium S transported from the roll medium support device 22. The roll medium support device 22 includes the shaft member 60, the support member 23, the lock section 70, the operation section 73, and the auxiliary member 80. The shaft member 60 is inserted into the roll medium R, in which the medium S is wound in a roll shape, along the axial line of the roll medium R. The support member 23 that includes the insertion hole 64 into which the shaft member 60 is insertable and the engagement section 75 engageable with the shaft member 60 and that is configured to move with respect to the shaft member 60 in the extending direction A of the shaft member 60 and that is configured to support the roll medium R from the extending direction A of the shaft member 60. The lock section 70 that is configured to contact the inner peripheral section 31a of the roll medium R and that is configured to fix the roll medium R in place. The operation section 73 is configured to allow user operation. The auxiliary member 80 is configured to be attachable to and detachable from the support member 23. The operation section 73 performs, by the operation from the position adjustment operation position (the first operation position) S1 to the position determined operation position (the second operation position) S2 being performed when the auxiliary member 80 is not attached to the support member 23, switching from the position adjustment state in which movement of the support member 23 with respect to the shaft member 60 is allowed in the extending direction A of the shaft member 60 to the positioned state in which movement of the support member 23 with respect to the shaft member 60 in the extending direction A of the shaft member 60 is limited and, in conjunction, switching from the unlocked state in which the lock section 70 does not contact the inner peripheral section 31a of the roll medium R to the locked state in which the lock section 70 contacts the inner peripheral section 31a of the roll medium R. by being attached to the support member 23, the auxiliary member 80 sets the support member 23 into the positioned state even when the operation section 73 is in the position adjustment operation position S1.

According to this configuration, even when the operation section 73 is in the position adjustment operation position S1, the support member 23 can be in the positioned state. For example, it is possible to solve a problem that the user who repeatedly uses the roll medium R having the same width size is forced to adjust the position of the support member 23 which does not needs to change the position with respect to the shaft member 60 every time. Therefore, the work efficiency when the roll medium R is replaced with respect to the roll medium support device 22 is improved.

(2) The lock section 70 and the operation section 73 are provided on the support member 23.

According to this configuration, since the lock section 70 and the operation section 73 are provided in the support member 23 and are configured as one component, the number of components to be handled in the work of replacing the roll medium R using the roll medium support device 22 can be reduced. Therefore, the work efficiency when performing the replacement work of the roll medium R is improved.

(3) The operation section 73 is a lever that, when pulled up with respect to the support member 23 as an operation to the position adjustment operation position S1, sets the support member 23 into the position adjustment state and that, when folded down with respect to the support member 23 as an operation to the position determined operation position S2, sets the support member into the positioned state.

According to this configuration, since the operation section 73 is folded down when the shaft member 60 and the engagement section 75 are set to the positioned state, the operation section 73 is unlikely to be an obstacle when the roll medium support device 22 is set in the printing device 11.

(4) The support member 23 includes the movable member 74 configured to restrict a displacement amount of the engagement section 75 in a direction in which the engagement section 75 moves away from the shaft member 60, the support member 23 is placed into the position adjustment state by the operation section 73 operating to the position adjustment operation position S1 and the movable member 74 moving to the first position in which the displacement amount is allowed to be displacement amount in which the engagement between the engagement section 75 and the shaft member 60 is disengable, and the support member 23 is placed into the positioned state by the operation section 73 operating to the position determined operation position S2 and the movable member 74 moving to the second position in which the displacement amount is restrictable within a range in which engagement between the engagement section 75 and the shaft member 60 is not disengagement.

According to this configuration, since the movable member 74 moves in accordance with the operation position at which the operation section 73 is operated, it is possible to switch between a position adjustment state, in which the position of the support member 23 can be adjusted with respect to the shaft member 60 and a positioned state, in which the support member 23 is positioned with respect to the shaft member 60.

(5) The auxiliary member 80 is a member that is configured to enable insertion of the shaft member 60 and that is independent from the support member 23 and, by the shaft member 60 being attached at the attached position corresponding to the engagement section 75 with respect to the support member 23 through which the shaft member 60 is inserted in a state in which the shaft member 60 is inserted through the auxiliary member 80, the auxiliary member 80 restricts displacement amount of the engagement section 75 in the direction in which the engagement between the engagement section 75 and the shaft member 60 disengages to within a range in which the engagement is not disengaged.

According to this configuration, by inserting the auxiliary member 80 into which the shaft member 60 is inserted into the inserted position with respect to the support member 23, the shaft member 60 and the support member 23 can be maintained in the positioned state regardless of the operation position of the operation section 73.

(6) The auxiliary member 80 includes the base section 81 through which the shaft member 60 is inserted and the auxiliary restriction section 82 that extends from the base section 81 and that, when the auxiliary member 80 is attached to the attachment section 79 of the support member 23, restricts displacement amount of the engagement section 75 within a range in which the engagement is not disengaged to a position different from the position at which the movable member 74 restricts the displacement amount of the engagement section 75.

According to this configuration, by attaching the auxiliary member 80 to the support member 23, the displacement amount of the engagement section 75 is restricts by the auxiliary restriction section 82 at a position different from the position where the movable member 74 restricts the displacement amount of the engagement section 75 within a range that does not disengage the engagement. Therefore, the support member 23 and the shaft member 60 can be maintained in the positioned state regardless of the operating position of the operation section 73.

(7) The auxiliary member 80 has the outer diameter smaller than the inner diameter of the hole of the core material of the roll medium R and is attached to the support member 23 from the inside in the width direction of the roll medium R.

According to this configuration, since the auxiliary member 80 is inserted into the support member 23 from the inner side in the width direction of the roll medium R, the outer size of the roll medium support device 22 does not change regardless of the presence or absence of the auxiliary member 80. Therefore, it is not necessary to change the housing space on the printing device 11 side that houses the roll medium support device 22. Even when the auxiliary member 80 is not inserted into the support member 23, since the auxiliary member 80 can be placed in a state in which the shaft member 60 is inserted, the usability of the auxiliary member 80 is easy to use The auxiliary member 80 is less likely to be lost.

(8) Two of the support member 23 are provided corresponding to both sides in the width direction of the roll medium R and each of the two support members 23 are configured to attach the auxiliary member 80.

According to this configuration, the user can attach the auxiliary member 80 to the desired one of the two support members 23. The user can select one support member 23 on the side desired to be maintained in the positioned state with respect to the shaft member 60.

(9) The auxiliary member 80 includes the disengagement restriction section 87 that restricts movement in a direction that would cause disengagement from the attaching position where the auxiliary restriction section 82 is attached to the attachment section 79 of the support member 23.

According to this configuration, it is possible to prevent the auxiliary restricting section 82 of the auxiliary member 80 from being detached from the attaching position where the auxiliary restriction section 82 is attached in a state of restricting the displacement amount of the engagement section 75 of the support member 23.

(10) The roll medium support device 22 supports the roll medium R, where the medium S is wound in a roll shape. The roll medium support device 22 includes the shaft member 60, the support member 23, the lock section 70, and the operation section 73. The shaft member 60 is inserted into the roll medium R, in which the medium S is wound in a roll shape, along the axial line of the roll medium R. The support member 23 that includes the insertion hole 64 into which the shaft member 60 is insertable and the engagement section 75 engageable with the shaft member 60 and that is configured to move with respect to the shaft member 60 in the extending direction A of the shaft member 60 and that is configured to support the roll medium R from the extending direction A of the shaft member 60. The lock section 70 that is configured to contact the inner peripheral section 31a of the roll medium R and that is configured to fix the roll medium R in place. The operation section 73 that is configured to allow user operation and that, by an operation from the position adjustment operation position (the first operation position) S1 to the position determined operation position (the second operation position) S2 being performed when the auxiliary member 80, which is configured to be attachable to and detachable from the support member 23, is not attached to the support member 23, performs switching from the position adjustment state in which movement of the support member 23 with respect to the shaft member 60 is allowed in the extending direction A of the shaft member 60 to the positioned state in which movement of the support member 23 with respect to the shaft member 60 in the extending direction A of the shaft member 60 is limited and, in conjunction, switching from the unlocked state in which the lock section 70 does not contact the inner peripheral section 31a of the roll medium R to the locked state in which the lock section 70 contacts the inner peripheral section 31a of the roll medium R. By the auxiliary member 80 being attached, the support member 23 is in the positioned state even when the operation section 73 is in the position adjustment operation position S1.

According to this configuration, by attaching the auxiliary member 80 to the support member 23 of the roll medium support device 22, even when the operation section 73 is at the position adjustment operation position S1, it is possible to set the support member 23 to a positioned state in which the movement of the support member 23 with respect to the shaft member 60 is limited.

(11) The auxiliary member 80 is attached to the roll medium support device 22 for supporting the roll medium R on which the medium S is wound in a roll shape. The roll medium support device 22 includes the shaft member 60, the support member 23, the lock section 70, and the operation section 73. The shaft member 60 is inserted into the roll medium R, in which the medium S is wound in a roll shape, along the axial line of the roll medium R. The support member 23 that includes the insertion hole 64 into which the shaft member 60 is insertable and the engagement section 75 engageable with the shaft member 60 and that is configured to move with respect to the shaft member 60 in the extending direction A of the shaft member 60 and that is configured to support the roll medium R from the extending direction A of the shaft member 60. The lock section 70 that is configured to contact the inner peripheral section 31a of the roll medium R and that is configured to fix the roll medium R in place. The operation section 73 is configured to allow user operation. The operation section 73 performs, by the operation from the position adjustment operation position (the first operation position) S1 to the position determined operation position (the second operation position) S2 being performed when the auxiliary member 80 is not attached to the support member 23, switching from the position adjustment state in which movement of the support member 23 with respect to the shaft member 60 is allowed in the extending direction A of the shaft member 60 to the positioned state in which movement of the support member 23 with respect to the shaft member 60 in the extending direction A of the shaft member 60 is limited by engagement of the shaft member 60 and the engagement section 75 and, in conjunction, switching from the unlocked state in which the lock section 70 does not contact the inner peripheral section 31a of the roll medium R to the locked state in which the lock section 70 contacts the inner peripheral section 31a of the roll medium R. The auxiliary member 80 includes an auxiliary restriction section 82 that is configured to be attachable to and detachable from the support member 23 and that, by being attached to the support member 23, restricts the displacement amount in a direction in which the engagement section 75 is disengaged from the shaft member 60 to be equal to or less than the displacement amount in which the engagement between the engagement section 75 and the shaft member 60 is not disengaged, and the auxiliary member 80 sets the support member 23 into the positioned state even when the operation section 73 is in the position adjustment operation position S1. According to this configuration, by attaching the auxiliary member 80 to the support member 23 of the roll medium support device 22, even when the operation section 73 is operated to the position adjustment operation position S1, the support member 23 can be placed in the positioned state in which the movement of the support member 23 with respect to the shaft member 60 is limited.

### Modifications

Note that the above embodiment may be modified as follows.
Attachment of the auxiliary restriction section 82 to the support member 23 may be fitting or insertion to the support member 23. For example, it may be loosely fitted to the extent that it touches the inner wall surface, or it may be inserted with a gap. In short, it is sufficient that by the auxiliary restriction section 82 attached to the support member 23 can restrict the engagement section 75 so as not to be disengaged from the predetermined engagement groove 65. For example, even if the engagement section 75 is displaced in a direction away from the engagement groove 65, it is sufficient that the displacement amount can be restricted within a range that does not allow the inner wall surface of the engagement groove 65 to be get over. By the auxiliary member 80, the displacement amount of the engagement section 75 in a direction away from the shaft member 60 may be configured to restrict to zero. When the auxiliary member 80 is attached to the support member 23, the auxiliary restriction section 82 may be configured to press the engagement section 75 in a direction approaching the shaft member 60 (radially inward).
The auxiliary member 80 may be configured to have no hole through which the shaft member 60 can be inserted.
The auxiliary member 80 is not limited to one component, and may be constituted by a plurality of components such as two components or three or more components. For example, by constituting one component for each auxiliary restriction section 82, it may be a plurality of components.
The auxiliary member 80 may be constructed in one component together with the support member 23. That is, the auxiliary member 80 may be part of the support unit 24. For example, the auxiliary member 80 may be assembled to the support member 23 in a movable configuration, allowing the user to perform the operation of selecting the position adjustment state and the positioned state. In this case, an operation section dedicated to the auxiliary member may be provided separately from the operation section 73. The operation section dedicated to the auxiliary member may be provided inside the support member 23 or may be provided on the outside together with the operation section 73. The operation section dedicated to the auxiliary member may be a push type, a slide type, a rotary type, or a lever type.
The auxiliary member 80 may be attached from the outer surface side of the support member 23.
The auxiliary member 80 may be attached to only a predetermined one of the pair of support members 23.
When the operation section 73 is the lever, the operation direction may be a direction of rotation around the axial line J. The operation section 73 is not limited to the lever, and may be a handle or a push button.
The number of the engagement grooves 65 provided in the shaft member 60 may be one each.
The number of the engagement sections 75 of the support member 23 may be one or a plurality of three or more.
The engagement section 75 may be configured by an indented portion (for example, an engagement groove), and each of the engagement grooves 65 provided in the shaft member 60 may be changed to a convex portion (for example, an engagement claw) that can engage with the indented portion of the engagement section 75.
The cross-sectional shape of the shaft member 60 is not limited to a substantially quadrangular shape, and may be any polygonal shape such as a triangular shape, a pentagonal shape, a hexagonal shape, or an octagonal shape, or may be a circular shape or an elliptical shape. In this case, according to the shape of the shaft member 60, the shape of the insertion hole 64 of the support member 23 is also the same.
The medium S constituting the roll medium R may be, for example, a cloth, a plastic film, or a metal foil.
The printing device 11 may be a dot impact type or an electrophotographic type printer as well as the inkjet type printer. The image forming device is not limited to a printing-only device, and may be a multifunction peripheral having a copy function and a scanner function.
The printing device 11 may be a line printer or a page printer. A lateral type printer in which the carriage 46 is movable in two directions of a main scanning direction and a sub-scanning direction may be used.
The printing device 11 may be a small, medium, or large printer. For example, it may be a business printer or a large-format printer. The printing device 11 may be a textile printing device.
In the above described embodiment, the printing device 11 may be a fluid ejecting device that performs printing by ejecting a fluid other than ink (including a liquid, a liquid material in which particles of a functional material are dispersed or mixed in a liquid, a fluid material such as a gel, and a solid that can be ejected by flowing as a fluid). For example, the liquid material ejecting device may be performs printing by ejecting a liquid material containing a material such as an electrode material or a color material (pixel material) used in the manufacture of a liquid crystal display, an electroluminescence (EL) display, a surface emitting display, or the like in a dispersed or dissolved form. It may be a fluid ejecting device for ejecting a fluid such as a gel (for example, physical gel) or a powder-granule ejecting device for ejecting a solid such as a powder (powder-granule) such as toner as an example. The present disclosure can be applied to any one type of the fluid ejecting devices. Note that in the present specification, the “fluid” is a concept that does not include a fluid formed of only a gas, and the fluid includes, for example, a liquid (including an inorganic solvent, an organic solvent, a solution, a liquid resin, a liquid metal (metal melt), and the like), a liquid, a fluid, a powder-granule (including a granular and a powder), and the like.
The roll medium support device 22 is not limited to a device provided in the printing device 11 that performs the printing process on the roll medium R, and may be a device provided in various processing devices that perform any process on the roll medium R.

Hereinafter, technical ideas derived from the above described embodiment and modifications and effects thereof will be described.

(A) A printing device includes a roll medium support device configured to support a roll medium in which a medium is wound in a roll shape and a printing section configured to print on the medium transported from the roll medium support device, wherein the roll medium support device includes a shaft member that is inserted into the roll medium, in which the medium is wound in a roll shape, along an axial line of the roll medium, a support member that includes an insertion hole into which the shaft member is insertable and an engagement section engageable with the shaft member, that is configured to move with respect to the shaft member in an extending direction of the shaft member, and that is configured to support the roll medium from the extending direction of the shaft member, a lock section that is configured to contact an inner peripheral section of the roll medium and that is configured to fix the roll medium in place, an operation section configured to allow user operation, and an auxiliary member configured to be attachable to and detachable from the support member, the operation section, by an operation from a first operation position to a second operation position being performed when the auxiliary member is not attached to the support member, performs switching from a position adjustment state in which movement of the support member with respect to the shaft member is allowed in the extending direction of the shaft member to a positioned state in which movement of the support member with respect to the shaft member in the extending direction of the shaft member is limited and, in conjunction, switching from an unlocked state in which the lock section does not contact the inner peripheral section of the roll medium to a locked state in which the lock section contacts the inner peripheral section of the roll medium, and by being attached to the support member, the auxiliary member sets the support member into the positioned state even when the operation section is in the first operation position.

According to this configuration, even when the operation section is in the first operation position, the support member can be in the positioned state. For example, it is possible to solve a problem that the user who repeatedly uses the roll medium having the same width size is forced to adjust the position of the support member which does not needs to change the position with respect to the shaft member every time. Therefore, the work efficiency when the roll medium is replaced with respect to the roll medium support device is improved.

(B) The printing device according to the above aspect (A) may be such that the lock section and the operation section are provided on the support member. According to this configuration, since the lock section and the operation section are provided in the support member and are configured as one component, the number of components to be handled in the work of replacing the roll medium using the roll medium support device can be reduced. Therefore, the work efficiency when performing the replacement work of the roll medium R is improved.

(C) The printing device according to the above aspects (A) or (B) may be such that the operation section is a lever that, when pulled up with respect to the support member as an operation to the first operation position, sets the support member into the position adjustment state and that, when folded down with respect to the support member as an operation to the second operation position, sets the support member into the positioned state.

According to this configuration, since the operation section is folded down when the shaft member and the engagement section are set to the positioned state, the operation section is unlikely to be an obstacle when the roll medium support device is set in the printing device.

(D) The printing device according to any one of the above aspects (A) to (C) may be such that the support member includes a movable member configured to restrict a displacement amount of the engagement section in a direction in which the engagement section moves away from the shaft member, the support member is placed into the position adjustment state by the operation section operating to the first operation position and the movable member moving to a first position in which the displacement amount is allowed to be a displacement amount in which the engagement between the engagement section and the shaft member is disengagable, and the support member is placed into the positioned state by the operation section operating to the second operation position and the movable member moving to a second position in which the displacement amount is restrictable within a range in which engagement between the engagement section and the shaft member is not disengaged.

According to this configuration, since the movable member moves in accordance with the operation position at which the operation section is operated, it is possible to switch between a position adjustment state, in which the position of the support member can be adjusted with respect to the shaft member and a positioned state, in which the support member is positioned with respect to the shaft member.

(E) The printing device according to any one of the above aspects (A) to (D) may be such that the auxiliary member is a member that is configured to enable insertion of the shaft member and that is independent from the support member and, by the shaft member being attached at an attached position corresponding to the engagement section with respect to the support member through which the shaft member is inserted in a state in which the shaft member is inserted through the auxiliary member, the auxiliary member restricts displacement amount of the engagement section in the direction in which the engagement between the engagement section and the shaft member disengages to within a range in which the engagement is not disengaged.

According to this configuration, by inserting the auxiliary member into which the shaft member is inserted into the inserted position with respect to the support member, the shaft member and the support member can be maintained in the positioned state regardless of the operation position of the operation section.

(F) The printing device according to any one of the above aspects (A) to (E) may be such that the auxiliary member includes a base section through which the shaft member is inserted and an auxiliary restriction section that extends from the base section and that, when the auxiliary member is attached to the attachment section of the support member, restricts displacement amount of the engagement section within a range in which the engagement is not disengaged to a position different from the position at which the movable member restricts the displacement amount of the engagement section.

According to this configuration, by attaching the auxiliary member to the support member, the displacement amount of the engagement section is restricts by the auxiliary restriction section at a position different from the position where the movable member restricts the displacement amount of the engagement section within a range that does not disengage the engagement. Therefore, even when the operation section is in the first operation position, the support member can be in the positioned state.

(G) The printing device according to any one of the above aspects (A) to (F) may be such that the auxiliary member has an outer diameter smaller than an inner diameter of a hole of a core material of the roll medium and is attached to the support member from the inside in a width direction of the roll medium.

According to this configuration, since the auxiliary member is inserted into the support member from the inner side in the width direction of the roll medium, the outer size of the roll medium support device does not change regardless of the presence or absence of the auxiliary member. Therefore, it is not necessary to change the housing space on the printing device side that houses the roll medium support device. Even when the auxiliary member is not inserted into the support member, since the auxiliary member can be placed in a state in which the shaft member is inserted, the usability of the auxiliary member is easy to use. The auxiliary member is less likely to be lost.

(H) The printing device according to any one of the above aspects (A) to (G) may be such that two of the support members are provided corresponding to both sides in the width direction of the roll medium and each of the two support members are configured to attach the auxiliary member. According to this configuration, the user can attach the auxiliary member to the desired one of the two support members. The user can select one of the support member on the side desired to be maintained in the positioned state with respect to the shaft member.

(I) The printing device according to any one of the above aspects (A) to (H) may be such that
the auxiliary member includes a disengagement restriction section that restricts movement in a direction that would cause disengagement from an attaching position where the auxiliary restriction section is attached to the attachment section of the support member.

According to this configuration, it is possible to prevent the auxiliary restricting section of the auxiliary member from being detached from the attaching position where the auxiliary restriction section is attached in a state of restricting the displacement amount of the engagement section of the support member.

(J) A roll medium support device for supporting a roll medium in which a medium is wound in a roll shape, the roll medium support device includes a shaft member that is inserted into the roll medium, in which the medium is wound in a roll shape, along an axial line of the roll medium; a support member that includes an insertion hole into which the shaft member is insertable and an engagement section engageable with the shaft member, that is configured to move with respect to the shaft member in an extending direction of the shaft member, and that is configured to support the roll medium from the extending direction of the shaft member; a lock section that is configured to contact an inner peripheral section of the roll medium and that is configured to fix the roll medium in place; and an operation section that is configured to allow user operation and that, by an operation from a first operation position to a second operation position being performed when an auxiliary member, which is configured to be attachable to and detachable from the support member, is not attached to the support member, performs switching from a position adjustment state in which movement of the support member with respect to the shaft member is allowed in the extending direction of the shaft member to a positioned state in which movement of the support member with respect to the shaft member in the extending direction of the shaft member is limited and, switching from an unlocked state in which the lock section does not contact the inner peripheral section of the roll medium to a locked state in which the lock section contacts the inner peripheral section of the roll medium, wherein by the auxiliary member being attached, the support member is in the positioned state even when the operation section is in the first operation position.

According to this configuration, by attaching the auxiliary member to the support member of the roll medium support device, even when the operation section is in the first operation position, the support member can be in the positioned state.

(K) The auxiliary member that is attached to a roll medium support device for supporting a roll medium in which a medium is wound in a roll shape, the roll medium support device including a shaft member that is inserted into the roll medium, in which the medium is wound in a roll shape, along an axial line of the roll medium; a support member that includes an insertion hole into which the shaft member is insertable and an engagement section engageable with the shaft member, that is configured to move with respect to the shaft member in an extending direction of the shaft member, and that is configured to support the roll medium from the extending direction of the shaft member; a lock section that is configured to contact an inner peripheral section of the roll medium and that is configured to fix the roll medium in place; and an operation section that is configured to allow user operation and that, by an operation from a first operation position to a second operation position being performed when the auxiliary member is not attached to the support member, performs switching from a position adjustment state in which movement of the support member with respect to the shaft member is allowed in the extending direction of the shaft member to a positioned state in which movement of the support member with respect to the shaft member in the extending direction of the shaft member is limited by engagement of the shaft member and the engagement section and, switching from an unlocked state in which the lock section does not contact the inner peripheral section of the roll medium to a locked state in which the lock section contacts the inner peripheral section of the roll medium, wherein the auxiliary member includes an auxiliary restriction section that is configured to be attachable to and detachable from the support member and that, by being attached to the support member, restricts the displacement amount in a direction in which the engagement section is disengaged from the shaft member to be equal to or less than the displacement amount in which the engagement between the engagement section and the shaft member is not disengaged, and the auxiliary member sets the support member into the positioned state even when the operation section is in the first operation position.

According to this configuration, by attaching the auxiliary member to the support member of the roll medium support device, even when the operation section is in the first operation position, it is possible to the support member to the first operation position.

What is claimed is:

1. A printing device comprising:
a roll medium support device configured to support a roll medium in which a medium is wound in a roll shape and
a printing section configured to print on the medium transported from the roll medium support device, wherein
the roll medium support device includes
a shaft member that is inserted into the roll medium, in which the medium is wound in a roll shape, along an axial line of the roll medium,
a support member that includes an insertion hole into which the shaft member is insertable and an engagement section engageable with the shaft member, that is configured to move with respect to the shaft member in an extending direction of the shaft member, and that is configured to support the roll medium from the extending direction of the shaft member,
a lock section that is configured to contact an inner peripheral section of the roll medium and that is configured to fix the roll medium in place,
an operation section configured to allow user operation, and
an auxiliary member configured to be attachable to and detachable from the support member,
the operation section performs,
by an operation from a first operation position to a second operation position being performed when the auxiliary member is not attached to the support member,
switching from a position adjustment state in which movement of the support member with respect to the shaft member is allowed in the extending direction of the shaft member to a positioned state in which movement of the support member with respect to the shaft member in the extending direction of the shaft member is limited and,
in conjunction, switching from an unlocked state in which the lock section does not contact the inner peripheral section of the roll medium to a locked state in which the lock section contacts the inner peripheral section of the roll medium, and
by being attached to the support member, the auxiliary member sets the support member into the positioned state even when the operation section is in the first operation position.

2. The printing device according to claim 1, wherein
the lock section and the operation section are provided on the support member.

3. The printing device according to claim 1, wherein
the operation section is a lever that, when pulled up with respect to the support member as an operation to the first operation position, sets the support member into the position adjustment state and that, when folded down with respect to the support member as an operation to the second operation position, sets the support member into the positioned state.

4. The printing device according to claim 1, wherein
the support member includes a movable member configured to restrict a displacement amount of the engagement section in a direction in which the engagement section moves away from the shaft member,
the support member is placed into the position adjustment state by the operation section operating to the first operation position and the movable member moving to a first position in which the displacement amount is allowed to be a displacement amount in which the engagement between the engagement section and the shaft member is disengagable, and
the support member is placed into the positioned state by the operation section operating to the second operation position and the movable member moving to a second position in which the displacement amount is restrictable within a range in which engagement between the engagement section and the shaft member is not disengaged.

5. The printing device according to claim 1, wherein
the auxiliary member is a member that is configured to enable insertion of the shaft member and that is independent from the support member and, by the shaft member being attached at an attached position corresponding to the engagement section with respect to the support member through which the shaft member is inserted in a state in which the shaft member is inserted through the auxiliary member, the auxiliary member restricts displacement amount of the engagement section in the direction in which the engagement between the engagement section and the shaft member disengages to within a range in which the engagement is not disengaged.

6. The printing device according to claim 4, wherein
the auxiliary member includes a base section through which the shaft member is inserted and an auxiliary restriction section that extends from the base section and that, when the auxiliary member is attached to the attachment section of the support member, restricts displacement amount of the engagement section within a range in which the engagement is not disengaged to a position different from the position at which the movable member restricts the displacement amount of the engagement section.

7. The printing device according to claim 1, wherein
the auxiliary member has an outer diameter smaller than an inner diameter of a hole of a core material of the roll medium and is attached to the support member from the inside in a width direction of the roll medium.

8. The printing device according to claim 1, wherein
two of the support member are provided corresponding to both sides in the width direction of the roll medium and
each of the two support members are configured to attach the auxiliary member.

9. The printing device according to claim 6, wherein
the auxiliary member includes a disengagement restriction section that restricts movement in a direction that would cause disengagement from an attaching position where the auxiliary restriction section is attached to the attachment section of the support member.

10. A roll medium support device for supporting a roll medium in which a medium is wound in a roll shape, the roll medium support device comprising:
a shaft member that is inserted into the roll medium, in which the medium is wound in a roll shape, along an axial line of the roll medium;
a support member that includes an insertion hole into which the shaft member is insertable and an engagement section engageable with the shaft member, that is configured to move with respect to the shaft member in an extending direction of the shaft member, and that is configured to support the roll medium from the extending direction of the shaft member;
a lock section that is configured to contact an inner peripheral section of the roll medium and that is configured to fix the roll medium in place; and
an operation section that is configured to allow user operation and that,
by an operation from a first operation position to a second operation position being performed when an auxiliary member, which is configured to be attachable to and detachable from the support member, is not attached to the support member, performs
switching from a position adjustment state in which movement of the support member with respect to the shaft member is allowed in the extending direction of the shaft member to a positioned state in which movement of the support member with respect to the shaft member in the extending direction of the shaft member is limited and,
in conjunction, switching from an unlocked state in which the lock section does not contact the inner peripheral section of the roll medium to a locked state in which the lock section contacts the inner peripheral section of the roll medium, wherein
by the auxiliary member being attached, the support member is in the positioned state even when the operation section is in the first operation position.

11. An auxiliary member attached to a roll medium support device for supporting a roll medium in which a medium is wound in a roll shape, the roll medium support device including
a shaft member that is inserted into the roll medium, in which the medium is wound in a roll shape, along an axial line of the roll medium;
a support member that includes an insertion hole into which the shaft member is insertable and an engagement section engageable with the shaft member, that is configured to move with respect to the shaft member in an extending direction of the shaft member, and that is configured to support the roll medium from the extending direction of the shaft member;
a lock section that is configured to contact an inner peripheral section of the roll medium and that is configured to fix the roll medium in place; and
an operation section that is configured to allow user operation and that,
by an operation from a first operation position to a second operation position being performed when the auxiliary member is not attached to the support member, performs
switching from a position adjustment state in which movement of the support member with respect to the shaft member is allowed in the extending direction of the shaft member to a positioned state in which movement of the support member with respect to the shaft member in the extending direction of the shaft member is limited by engagement of the shaft member and the engagement section and,
in conjunction, switching from an unlocked state in which the lock section does not contact the inner peripheral section of the roll medium to a locked state in which the lock section contacts the inner peripheral section of the roll medium, wherein
the auxiliary member includes an auxiliary restriction section that is configured to be attachable to and detachable from the support member and that, by being attached to the support member, restricts the displacement amount in a direction in which the engagement section is disengaged from the shaft member to be equal to or less than the displacement amount in which the engagement between the engagement section and the shaft member is not disengaged, and the auxiliary member sets the support member into the positioned state even when the operation section is in the first operation position.
